(19) United States
(12) Patent Application Publication
(10) Pub. No.: US 2010/0229194 A1
(43) Pub. Date: Sep. 9, 2010

(54) SYSTEM AND METHOD FOR REMOTE CONTROL BASED CUSTOMIZATION

(75) Inventors: Robert Blanchard, Escondido, CA (US); Mehrdad Memarnegad, San Diego, CA (US); Peter Shintani, San Diego, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Tokyo (JP); SONY ELECTRONICS INC., Parkridge, NJ (US)

(21) Appl. No.: 12/397,198

(22) Filed: Mar. 3, 2009

(51) Int. Cl. G06F 3/00; G05B 19/00

(52) U.S. Cl. 725/39; 340/5.8

(57) ABSTRACT

A system and method for customizing a user interface. The method includes receiving an input signal from a remote control device. The input signal may include an input command and identification information operable to be used for identifying the remote control device. A determination is made as to whether the remote control device has sufficient rights for execution of the input command by a content access system. In response to a determination of sufficient rights, a profile associated with the remote control is accessed. A customized user interface is then presented according to the profile.

### FIELD OF THE INVENTION

Embodiments of the present invention are generally related to remote control functionality for content presentation devices and systems, such as televisions.

### BACKGROUND OF THE INVENTION

As technology advances, content access devices including display devices such as televisions and media players such as digital video disc (DVD) players are increasingly being used by multiple people in a household. Often each device comes with only a single remote control device meaning that each user has complete control to access all the features of the device. For example, a child may be able to access content deemed inappropriate, such as rated R content, or be able to adjust display settings such as brightness. Similarly, the amount of content has increased rapidly necessitating electronic program guides (EPGs) to help users navigate the many content choices. Unfortunately, increases in the quantity of content have made efficient navigation of the content difficult using a remote control device.

Conventional systems have allowed content restrictions such as V chip blocking to be put in place. However, the content restrictions require users with access privileges to be authenticated before accessing restricted content. This can quickly become cumbersome if a parent needs to routinely to enter a password each time he or she wishes to access certain content.

Further, users may each prefer different device settings. For example, a user may prefer particular settings such as a particular brightness setting, list of favorite channels, etc. and thus may have to adjust these settings each time he or she uses a television. Unfortunately, other users are impacted by the settings configured by the previous users and may need to change the configuration routinely to watch content with their preferred settings.

### SUMMARY OF THE INVENTION

Thus, a need exists for an electronic system that can provide customized features according to each user. Embodiments of the present invention provide a user interface customization system which may be integrated with a content access system (e.g., television, set top box, DVD player, etc.). The customized user interface may be customized based on an identifier that originates from one of many remote control devices and according to a profile of configuration settings associated with an identified remote control device. Thus, embodiments of the present invention allow multiple people use the same content access system while having a user interface customized to their particular preferences based on the remote control device that is used to interface with the system.

In one embodiment, the present invention is implemented as a method for customizing a user interface of a content access system (e.g., television, set top box, DVD player, etc.). The method includes receiving an input signal from a remote control device. The remote may be one of several remote control devices that are capable of interfacing with the content access system, e.g., supplied with the purchase or were purchased separately, each having unique identification information. The input signal may include an input command and identification information operable to be used for identifying the remote control device. A determination is then made as to whether the remote control device has sufficient rights for execution of the input command by the content access system. In response to a determination of sufficient rights, a profile associated with the particular identified remote control is accessed. A customized user interface is then presented according to the specific profile (e.g., the configuration settings in the profile).

In another embodiment, the present invention is implemented as a system for customizing a user interface using remote control devices. The system includes an execution rights module for determining whether a remote control command can be executed and a user interface module for customizing a user interface of the content access system based on a remote control profile. The system further includes a data store operable to store one or more remote control profiles and remote control identification information associated with each of the one or more remote control profiles. The remote control profiles may be preconfigured, manually configured, or configured based on configuration and user behavior monitoring. In this way, a user experience relating to the content access system varies based on the remote control device being used on the system.

The system may also optionally include a transmitter to transmit signals to devices with sufficient rights to execute a received input command. For example, a primary (e.g., parent's remote) remote control device may receive a signal sent via the transmitter to indicate that a restricted (e.g., child's remote) remote control device is issuing commands.

In this manner, embodiments of the present invention implement a mechanism for customizing user interfaces according to a remote control device being used and thereby customizing the user interface (e.g., functionality and content access) according to the user. Further, certain users (e.g., children) may use restricted remote control devices which have filtering settings enabled so the users only see appropriate content. Thus, each user may have a user experience tailored to his or her needs and certain users (e.g., child) may have customized access to content determined by another user (e.g., parent).

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary system for providing a customized user interface in accordance with one embodiment of the present invention.

FIG. 2 shows an exemplary content access system for providing a customized user interface in accordance with one embodiment of the present invention.

FIG. 3 shows an exemplary remote control system for controlling a content access system in accordance with one embodiment of the present invention.

FIG. 4 shows an exemplary communication diagram in accordance with one embodiment of the present invention.

FIG. 5 shows a flowchart of an exemplary process for customizing a user interface in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

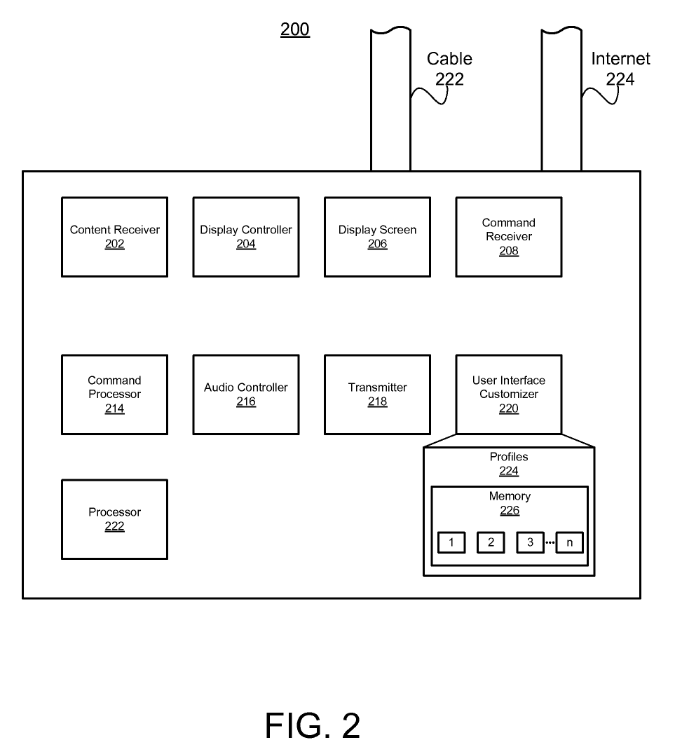

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., system 200 of FIG. 2), or similar electronic computing device, that manipulates and transforms data represented as physical (electronic) quantities within the computer system's registers and memories into other data similarly represented as physical quantities within the computer system memories or registers or other such information storage, transmission or display devices.

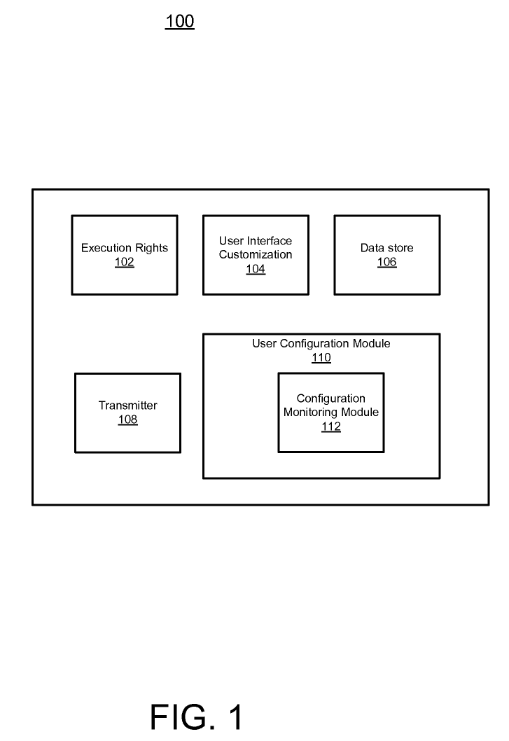

FIGS. 1 and 2 illustrate exemplary components used by various embodiments of the present invention. Although specific components are disclosed in systems 100 and 200 it should be appreciated that such components are examples. That is, embodiments of the present invention are well suited to having various other components or variations of the components recited in systems 100 and 200. It is appreciated that the components in systems 100 and 200 may operate with other components than other those presented, and that not all of the components of systems 100 and 200 may be required to achieve the goals of systems 100 and 200. It is appreciated that embodiments of system 100 include a variety of electronic devices that can be controlled remotely, including but not limited to computers, display devices, televisions, cathode ray tube (CRT) displays, computer monitors, liquid crystal displays (LCDs), plasma displays, projection displays, projectors, portable devices, game consoles, and handheld devices, set top box (STB), laserdisc, blu-ray player, digital versatile disc (DVD), IPTV, cable STB, etc.

FIG. 1 shows an exemplary electronic system operable for customizing a user interface in accordance with one embodiment of the present invention. System 100 may customize a user interface based on an identifier corresponding to a remote control device received along with an input command from the remote control device. Multiple remote control devices with different identifiers can be used to control system 100. The identifier can be sent via a variety of communication formats or protocols including, but not limited to, infrared (IR) or radio frequency (RF). System 100 includes execution rights module 102, user interface customization module 104, data store 106, optional transmitter module 108, and user configuration module 110.

Embodiments of the present invention are operable to customize a user interface relating to system 100 based on identification of one or more remote control devices and thereby expected users. It is appreciated that a variety of user identification mechanisms may be used including, but not limited to, a password, biometric measurements or readings (e.g., fingerprint scans), radio-frequency identification (RFID), and identification based on presence of a device (e.g., the presence of a specific Bluetooth device, e.g., cell phone, could allow a remote to be authorized to the level registered with a parent's Bluetooth device), etc. It is further appreciated that the identification based on a remote control device identifier removes the need of a user to change settings each time he or she uses the content access system (e.g., television) and further provides automatic and convenient identification.

Execution rights module 102 determines whether a remote control command can be executed. Executions rights module 102 uses the identification information received from a remote control device to determine whether a command received from the remote control is to be executed based on prescribed authorization settings related to each recognized remote control device.

Execution module 102 may determine whether an input command may be executed based on a priority hierarchy. The input command may be received from a master or primary remote control device (e.g., father or master remote), secondary (e.g., mother remote), or a restricted remote control device (e.g., child remote). Each remote control device may have different execution rights which execution module 102 uses to determine whether a command should be executed.

In one embodiment, execution module 102 may not execute commands for the restricted remote after a primary or secondary remote has executed commands. For example, if a primary remote control device (e.g., father remote control) was used to select a station or channel and shortly thereafter a restricted remote control device (e.g., child remote) issues a command, execution module 102 may determine that the command from the restricted remote is not to be executed. It is appreciated that the content access system could be supplied with multiple remotes with one remote preconfigured or defaulted as the master or primary remote control device and the others being secondary or restricted remote control devices.

In one embodiment, where unidirectional remote control devices are being used, the commands from a restricted remote may not be executed without feedback. In another embodiment, where bidirectional remote controls are being used, feedback may be provided to the primary and secondary remote control devices, as described herein, to notify the users of the primary or secondary remotes that a restricted remote is trying to have commands executed.

Execution rights module 102 may further set a time for which the restricted remote control device's commands will not be executed based on a last received command from the master remote. In one embodiment, the time is determined based on how long a program, track, or piece of content lasts. For example, the length of a television program may be determined based on the associated EPG data or Program System Protocol Information (PSIP) sent along with a digital broadcast. The restricted remote control device's commands may thus not be executed until the time period (e.g., program) is over. For instance, if the master remote selected a program to watch, the restricted remote could not change any channels until the program was over.

User interface customization module 104 customizes the functionality and settings of the electronic system based on a selected profile associated with the remote control. The user interface may provide customized access to content access system functionality based on the remote control profile. User interface customization module 104 may customize the user interface based on the remote control device identified for a variety of functions or settings including but not limited to, display of menus, menu items, turning picture on and off, changing volume, changing channel, brightness, contrast, white balance, picture settings, zoom, color mode, sound mode, picture mode, surround sound, invoking a channel guide, input selection, resolution setting, and selection of letter box of wide screen mode, languages, sub titles, object sizes, sound settings, and bass settings.

For example, a when a child or restricted remote invokes a menu, user interface customization module 104 may customize the graphical user interface so as to hide or not display a picture and brightness settings menu item or other advanced settings related to the picture quality. In contrast, a father's remote or primary remote may have access to the picture settings menu and the corresponding menu item may be displayed as part of a user interface customized by the user interface customization module 104. As another example, for a grandparent for which English is a second language, user interface customization module 104 may automatically increase the menu or EPG font size or change the display language based on the profile associated with the grandparent's remote control. Additionally user controlled options for closed captioning may be restricted to the grandparent's remote.

User interface customization module 104 may further customize content or content access based on the profile associated with the remote. User interface customization module 104 may customized the electronic programming guide (EPG) of a content access system. For example, when a child's or restricted remote control device is used to invoke an EPG, user interface customization module 104 automatically customizes the EPG to include only those stations or channels having PG or Y7 ratings or programming. Changing channels also automatically skips over blocked content. In one exemplary embodiment, a restricted or child's remote control device will have a TV tuned to the next available unrestricted channel (e.g., with available content) upon a channel up/down command.

User interface customization module 104 may thus remove R rated content and pay per view (PPV) content and also video on demand (VOD) content so as to prevent a child from making purchases or watching inappropriate or adult programming. It is appreciated that a profile associated with a restricted remote may come preconfigured to have V chip content blocking enabled. It is further appreciated that a restricted remote may be purchased separately with a predetermined identification that corresponds to a predefined restricted profile, in such a case little to no configuration of the profile associated with the restricted remote would be required.

User interface module 104 may also customize a favorites menu or channel map according to a remote control device profile. The customization of the favorites menu or channel map may thus allow multiple users of the content access system to each have their own set of favorites. For example, a father with a primary remote may have business and sports channels in his favorites, while a mother with a secondary remote has cooking and science channels in her favorites and a child with a restricted remote has cartoon channels in his favorites. It is appreciated the favorites menu or channel map could be part of an EPG display. For example, the EPG could be customized so as to include certain categories of stations first while other categories are not shown. A father using a primary remote may thus have sports stations listed first and have cartoons removed.

Data store 106 is operable to store one or more remote control profiles and remote control identification information associated with each of the one or more remote control profiles. The profiles may be preconfigured and may be further customized. The profiles may be configured via user configuration module 110.

Transmitter module 108 is operable to transmit a signal to a remote control device with sufficient rights to execute a received command. Transmitter module 108 may transmit a signal to a bidirectional remote control device in response to an input command received from a remote control device without sufficient rights. For example, transmitter module 108 may signal a primary or father remote after an input command has been received from a restricted or child remote. Transmitter 108 may further transmit a signal to the restricted remote that issued the command so that the restricted remote may provide audible or visual notification or feedback that remote is subservient to another remote control device.

User configuration module 110 facilitates setting of user configuration settings and storing the user configuration settings in a remote control profile. In one embodiment, the primary or father remote may utilize the functionality of user configuration module 110 to configure the settings for a secondary (e.g., mother) or restricted (e.g., child) remote. For example, the primary remote may be used to change the settings of the V chip blocking for the profile associated with the child's remote. Similarly, a secondary remote may be used to configure settings for the profile associated with the secondary remote and the child's remote.

User configuration module 110 may include configuration monitoring module 112. Configuration monitoring module 112 may observe or learn configurations settings (e.g., brightness, language, user interface element sizes, user channel selection, etc.) and store the user configurations via data store 106. For example, configuration monitoring module 112 may observe frequent selection of sports, news, and comedy channels and automatically add each channel to the favorites map associated with the remote control device used to make the selections. Furthermore, the configuration monitoring module may map the user settings for language and/or closed captioning for each remote or user. User configuration module 112 could further prompt a user to save selections to a profile associated with the remote control device.

In this fashion, embodiments of the present invention implement a process to automatically provide a customized user interface and behavior for each of one or more remotes used with the system. For example, each remote may have a set of favorite channels associated with the remote. Embodiments of the present invention further provide for certain remote control devices to have priority or precedence over other remotes. For example, commands from a child's remote may not be executed when a parent's remote is deemed to be active or has selected a program.

FIG. 2 shows an exemplary content access system for providing a customized user interface in accordance with one embodiment of the present invention. System 200 includes content receiver 202, display controller 204, display screen 206, command receiver 208, command processor 214, audio controller 216, transmitter 218, user interface customizer 220 (e.g., system 100), cable or satellite connection 222, internet connection 224, and processor 222. Processor 222 may carry out various operations for the various components of system 200.

Content receiver 202 receives content for system 200. Receiver 202 may receive signals including content from a variety of sources including, but not limited to, computers, computer networks, portable devices, set top boxes, over the air broadcasts, cable broadcasts, satellite broadcasts, Digital versatile Discs (DVDs), Blu-ray discs, Digital Video Broadcasting-Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), Internet Protocol Television (IPTV), etc. Content receiver 202 may receive content (e.g., electronic programming guide information and other content) via cable or satellite connection 222 and internet connection 224.

Display controller 204 controls display screen 206 of system 200. Display controller 204 may control a variety of display screens associated with system 200, including but not limited to, CRTs, LCDs, plasma displays, projection based, and Digital Light Processing (DLP) displays.

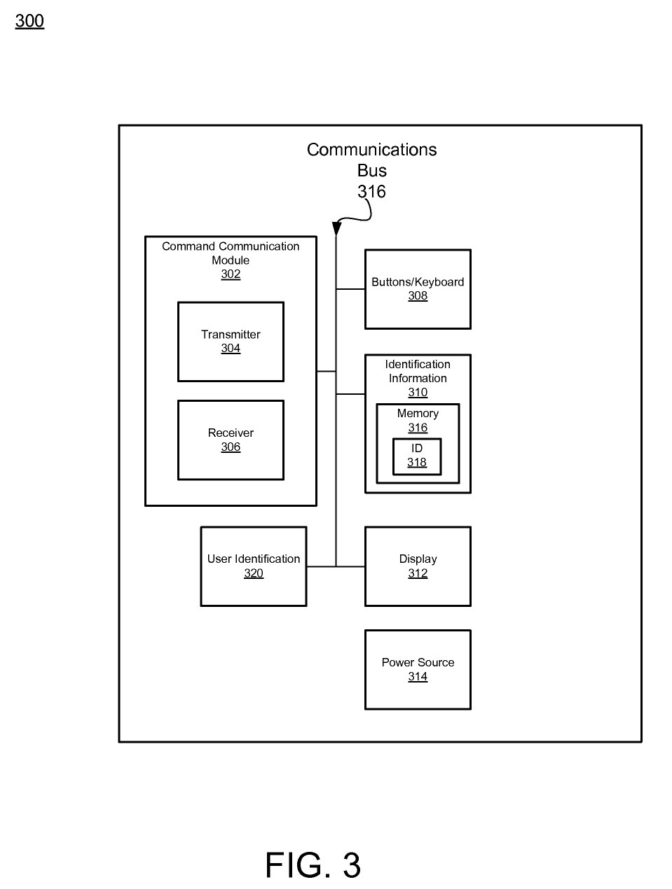

Command receiver 208 receives commands and identifies. Command receiver 208 may receive commands and identifiers via a variety of receivers including, but not limited to, infrared receiver and radio frequency receivers. The commands may have been issued via a remote control (e.g., system 300 of FIG. 3). Command receiver 208 is operable to receive commands and identifiers from multiple remotes control devices. Command receiver 208 is operable to pass the commands and identifiers received to user interface customizer 220.

Command processor 214 processes commands and identifiers received from user interface customizer 220. The commands received are processed and executed by system 200 via command processor 214 depending on the remote control identifier. For example, control codes (e.g., increase volume, change channel, EPG selection, launch an application, launch web browser, etc.) may be received by via an infrared receiver or radio frequency receiver, decoded, processed or filtered by user interface customizer 220 and sent to command processor 214.

In one exemplary embodiment, user interface customizer 200 includes profiles 224. Profiles 224 may include multiple profiles 1, 2, 3, n each corresponding to a remote control device. Each profile may include a variety of customization information including, but not limited to, user interface customization information (e.g., font size, language, functionality access, favorites, EPG customizations, V-Chip, closed captions, etc.), rights or privilege information (e.g., which remote controls are able to execute certain functions), usage information (e.g., for allowing a parent to track how much and what content a child is watching), and over-ride information (e.g., support for a command to be entered into a restricted or subordinate remote to over-ride a profile). In one embodiment, profiles 224 may be stored in memory 226. User interface customizer 220 thus filters or controls the commands received by command processor 214 based on profiles 224. In one embodiment, profiles 224 may be used to determine whether commands can be executed based on the presence of a master remote control. For example, a restricted remote may be able to access restricted features based on the presence of a master remote as an option. Similarly, the restricted remote may revert back to restricted functionality when the master remote is not present.

Audio controller 216 controls audio output for system 200 including a variety of outputs including, but not limited to, 2, 2.1, 3.1, 5.1, 6.1, 7.1, and 8.1 channel audio. The audio content may be received via content receiver 202. It is appreciated that audio controller 216 may output to audio equipment integrated within system 200.

Transmitter 218 may send signals to a remote control device (e.g., from transmitter module 108). The signals may include, but are not limited to, notification of input commands from subservient remote control devices (e.g., child or restricted remote control devices) and notification that commands are not being executed (e.g., to a child's remote).

FIG. 3 shows an exemplary remote control system for controlling a content access system in accordance with one embodiment of the present invention. System 300 includes command communication module 302, buttons/keypad 308, identification information module 310, optional display 312, power source 314, communication bus 316, and user identification module 320. Communications bus 316 facilitates communication between the components of system 300 including, but not limited to, command communication module 302, buttons/keypad 308, identification information module 310, optional display 312. In one embodiment, system 300 maybe a hand held remote control device.

Command communication module 302 includes a transmitter 304 operable to communicate control signals and an identification to a device (e.g., system 200). In one embodiment, command communication module 302 may be an infrared (IR) transmitter or a radio frequency (RF) transmitter. Transmitter 304 may further be operable to transmit signal indicating that a remote control device is active. For example, accelerometers or gyroscopes may be used to track the use of a primary or secondary remote and correspondingly a content access system may not execute commands from a restricted remote while the primary or second remotes are reported active via the accelerometers or gyroscopes. If a primary or secondary remote control device is deemed to be non active, transmitter 304 may signal the content access system (e.g., system 200) to prompt whether to relinquish control (e.g., “Do you wish to relinquish control to a subordinate remote control”).

Command communication module 302 may include optional receiver 306 which is operable to receive signals from the device being controlled (e.g., system 200). Receiver 306 may facilitate system 300 notifying a user that a command has been issued from a restricted remote that will not be executed. For example, a primary remote and a restricted remote control device may receive a signal that the restricted remote is trying to change the station. It is appreciated that embodiments of the present invention may use a variety of wireless communication formats or protocols including, but not limited to, 802.11a/b/g/n, Bluetooth, Z wave, or other wireless standards or protocols.

Buttons/keypad 308 allows entry of commands into system 300 which may then be used to control a device (e.g., system 200). Buttons/keypad 308 may include, but not limited to, navigations pads, keyboards (e.g., QWERTY), up/down button, and the like. Buttons/keypad 308 may be customized for specific users. For example, fewer or larger buttons for remote control devices for children, senior citizens, or the visually impaired.

Power source 316 provides power for system 300. Power source 316 may be portable power source including, but not limited to, batteries, rechargeable batteries (e.g., lithium ion, nickel metal hydride, nickel-cadmium, etc.).

Identification information module 310 facilitates automation of the user identification process by physically having different remote control units each with an identifier thereby facilitating each remote control device being associated with each viewer in a household. Identification information module 310 may include ID information 318 which includes identification information which may be transmitted with each command and used to identify system 300 (e.g., a remote control device) to a content presentation device (e.g., system 200). Identification information module 310 may further facilitate identification via user identification module 320. User identification module 320 may include a variety of user identification technologies including, but not limited to, passwords, biometric sensors (e.g., for fingerprint scans), and radio-frequency identification (RFID), and identification based on presence of a device (e.g., the presence of a specific Bluetooth device, e.g., cell phone, could allow a remote to be authorized to the level registered with a parent's Bluetooth device), etc. Identification information module 310 may provide different identification information based on a user identified via user identification module 320. User identification information module 320 may thus restrict users from using a particular remote control device (e.g., restrict children from using a master or parent's remote). It is appreciated that user identification module 320 may be optional and each or only certain remote control devices may have user identification technologies.

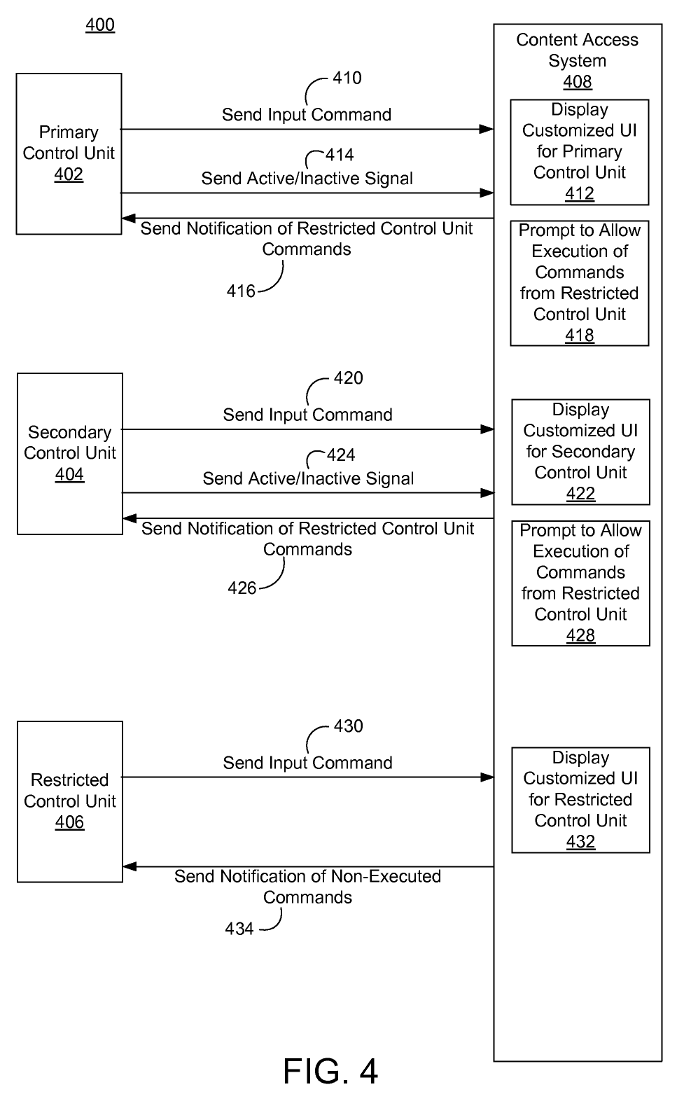

FIG. 4 shows an exemplary communication sequence 400 between a content access system 408 (e.g., system 200) and primary control unit 402, secondary control unit 404, and restricted control unit 406 in accordance with one embodiment of the present invention. It is appreciated that content access system 408 may receive command for any number of control units and such communication sequences as shown in FIG. 4 are exemplary. It is appreciated that the communications between control units 402-406 and content access system 408 may occur via a variety of interfaces including, but not limited to, an infrared transmitter/receiver, a radio frequency (RF) transmitter/receiver, or combination thereof etc.

At step 410, primary control unit 402 sends an input command to content access system 408. As described herein, the input command may include a variety of commands including, but not limited to, EPG navigation and channel selections, volume up/down, content access system settings menus, etc. In response to the input command, content access system 408 performs block 412 and displays a customized user interface (UI) for primary control unit 402 according to a first profile associated with primary control unit 402. Content access system 408 may thus continue to display a customized UI in response to input commands from primary control unit 402.

At step 414, an active/inactive signal is sent to content access system 408. As described herein, the active/inactive signal may be based on accelerometers or gyroscopes in primary control unit 402 for measuring movement or manipulation of control unit 402. If the active/inactive signal contains information indicating that primary control unit 402 is inactive, content access system 408 may perform block 418 and prompt to allow execution of command from a restricted control unit upon input commands being received from a restricted control unit.

At step 420, secondary control unit 404 sends an input command to content access system 408. In response to the input command, content access system 408 performs block 422 and displays a customized user interface (UI) for secondary control unit 404 according to a second profile associated with secondary control unit 404. Content access system 408 may thus continue to display a customized UI in response to input commands from secondary control unit 404.

At step 424, an active/inactive signal is sent to content access system 408. As described herein, the active/inactive signal may be based on accelerometers or gyroscopes in secondary control unit 404 for measuring movement or manipulation of control unit 404. If the active/inactive signal contains information indicating that secondary control unit 404 is inactive, content access system 408 may perform block 428 and prompt to allow execution of command from a restricted control unit upon input commands being received from a restricted control unit.

At step 430, restricted control unit 406 sends an input command to content access system 408. Content Access system 408 may determine whether the restricted remote has rights to have the input command executed. In response the restricted control unit having sufficient rights for execution of the input command, content access system 408 performs block 422 and displays a customized user interface (UI) for restricted control unit 406 according to a third profile associated with remote control unit 406. Content access system 408 may thus continue to display a customized UI in response to input commands from restricted control unit 406.

If the restricted control unit does not have sufficient rights to have the input command executed, content access system 408 may then perform step 434 and send notification of non-executed commands. In response, restricted control unit 406 may audible or visually indicate to the user (e.g., child) of a restricted control unit that commands are not being executed. In addition, content access system 408 may perform steps 416 and 426 and send notification to primary control unit 402 and secondary control unit 404 that a restricted control unit is sending commands to content access system 408. Primary control unit 402 and secondary control unit 404 may indicate audible or visual to the users (e.g., parents) of primary and second control units that a restricted control unit is sending commands.

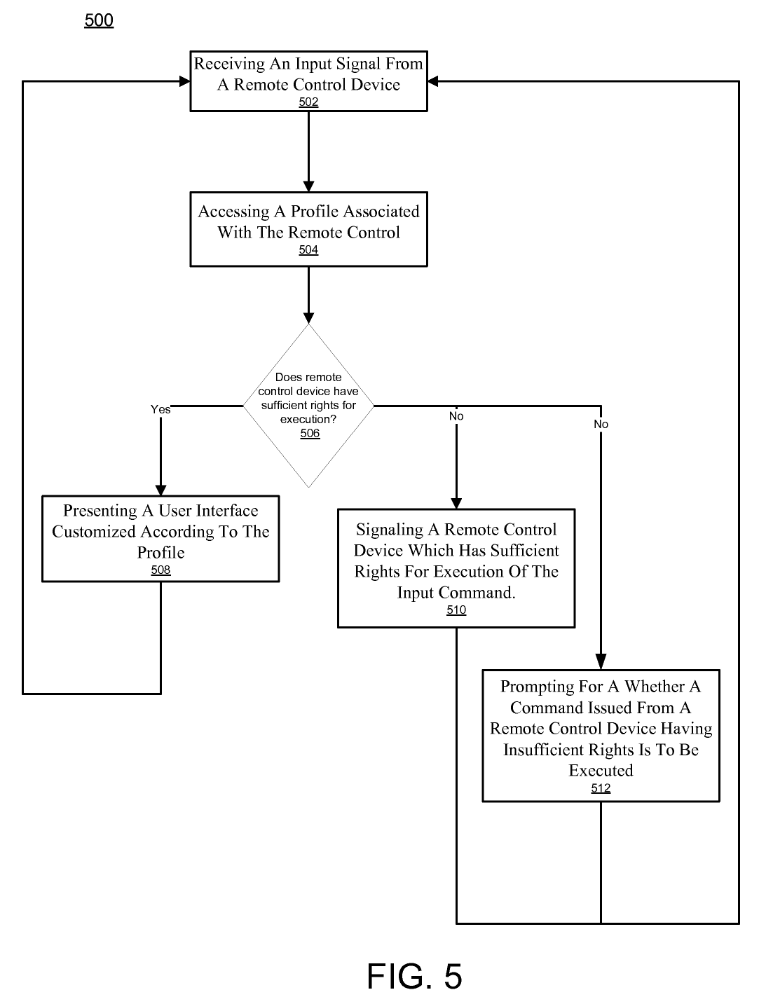

With reference to FIG. 5, flowchart 500 illustrates example functions used by various embodiments of the present invention. Flowchart 500 includes processes that, in various embodiments, are carried out by a processor under the control of computer-readable and computer-executable instructions which may be stored on a computer-readable medium. Although specific function blocks (“blocks”) are disclosed in flowchart 500, such steps are examples. That is, embodiments are well suited to performing various other blocks or variations of the blocks recited in flowchart 500. It is appreciated that the blocks in flowchart 500 may be performed in an order different than presented, and that not all of the blocks in flowchart 500 may be performed.

FIG. 5 shows a flowchart of a process for customizing a user interface in accordance with one embodiment of the present invention. The portions of flowchart 500 may be carried out by a content access system (e.g., system 200, content access system 408, television, etc.) and user interface customization module (e.g., user interface customizer 220 or system 100).

At block 502, an input signal is received from a remote control device. The input signal may include an input command and identification information operable to be used for identifying the remote control device. The input signal may be from one of multiple remotes sending the input signal to a TV, media source, or other content access system (set top box (STB), DVD player).

At block 504, a unique profile associated with the identified remote control is accessed. In one exemplary embodiment, the profile is selected based on the identification information in the input signal. At block 506, whether the remote control device has sufficient rights for execution of the input command is determined. As described herein, the identification information of the input signal may be compared to identification information in a data store (e.g., data store 106) comprising profiles (e.g., profiles 224) associated with remote control devices. The determination of rights may further be based on the length of time for a piece of content (e.g., TV program) determined based on an EPG selected from an unrestricted remote (e.g., primary or secondary remote control device).

At block 508, a user interface is customized according to the profile is presented. As described herein, the profile may include various user interface customization settings including, but removing user selectable elements, customized content, access to content access system functionality, customized EPGs, increased user element sizes, increased font size, and a favorites list.

At block 510, in response to a determination of insufficient rights, a remote control device which has sufficient rights for execution of the input command is signaled. As described herein, where a command has been received from a restricted (e.g., child's remote) remote control device, a signal may be sent to a primary or secondary remote control device (e.g., parent's remote) to indicate that a restricted remote is issuing commands. The restricted remote control devices may thus be signaled that it has insufficient rights.

At block 512, a prompt may be presented for as to whether a command issued from a remote control device having insufficient rights is to be executed. As described herein, if a command from a restricted remote will not be executed because of insufficient rights, a prompt that will be responsive to an input command from a primary or secondary remote control device may be presented to allow the commands from the restricted remote to be executed.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of customizing a user interface of an electronic device comprising:
receiving an input signal from a first remote control device, wherein said input signal comprises:
an input command; and
identification information operable to be used for identifying said first remote control device, among a plurality of remote control devices that are recognized by said electronic device;
in response to said identification information, accessing a first profile associated with said first remote control;
based on said first profile, determining whether said first remote control device has sufficient rights for execution of said input command; and
presenting a user interface customized according to said first profile.

2. The method of claim 1 further comprising:
signaling a second remote control device, wherein said second remote control device has sufficient rights for execution of said input command.

3. The method of claim 1 further comprising:
prompting as to whether a command issued from a remote control device having insufficient rights is to be executed.

4. The method of claim 1 wherein said user interface is customized to remove user selectable elements based on said first profile associated with said first remote control.

5. The method of claim 1 wherein said user interface comprises customized content based on said first profile associated with said first remote control.

6. The method of claim 1 further comprising:
receiving an input signal from a second remote control device; and
presenting a user interface customized according to a second profile associated with said second remote control device.

7. The method of claim 1 wherein said user interface comprises customized access to functionality of said electronic device based on said first profile associated with said first remote control.

8. The method of claim 1 wherein said user interface comprises a customized electronic programming guide (EPG) customized for said first remote control.

9. The method of claim 8 wherein elements of said EPG have customized font size.

10. The method of claim 9 wherein a length of time defining rights of said first remote control are determined based on program lengths specified in said EPG.

11. The method of claim 1 wherein said user interface comprises a favorites list.

12. A system for customizing a user interface of an electronic system comprising:
an execution rights module for determining whether a command originated from a specific remote control device can be executed;
a user interface module for customizing a user interface of said electronic system based on a remote control profile of a plurality of stored remote control profiles; and
a data store operable to store said plurality of remote control profiles and remote control identification information associated with each remote control profile.

13. A system as described in claim 12 further comprising:
a transmitter operable to transmit a signal to a remote control device with sufficient rights to execute a received command.

14. A system as described in claim 12 further comprising:
a user configuration module for facilitating user configuration of a remote control profile.

15. A system as described in claim 12 wherein said user interface comprises customized content based on said remote control profile associated with said specific remote control device.

16. A system as described in claim 12 wherein said user interface comprises customized access to content available on said electronic system based on said remote control profile.

17. A system as described in claim 12 wherein said user interface is customized to a language based on said remote control profile.

18. A computer readable media comprising instructions that when executed by a processor implement a method of customizing a user interface of an electronic device, said method comprising:
receiving an input signal from a first remote control device, wherein said input signal comprises:
an input command; and
identification information operable to be used for identifying said first remote control device, among a plurality of remote control devices that are recognized by said electronic device;
in response to said identification information, accessing a first profile associated with said first remote control;
based on said first profile, determining whether said first remote control device has sufficient rights for execution of said input command; and
presenting a user interface customized according to said profile.

19. The computer readable media of claim 18 wherein said identification information is based on a biometric sensor.

20. The computer readable media of claim 18 wherein said identification information is based on a radio-frequency communication.
